(19) United States
(12) Patent Application Publication
(10) Pub. No.: US 2017/0368432 A1
(43) Pub. Date: Dec. 28, 2017

(54) BLADE PROTECTOR AND GRIP

(71) Applicant: Lee Wright, Dundas (CA)

(72) Inventor: Lee Wright, Dundas (CA)

(21) Appl. No.: 15/698,933

(22) Filed: Sep. 8, 2017

Related U.S. Application Data
(63) Continuation-in-part of application No. PCT/CA2016/050255, filed on Mar. 9, 2016.
(60) Provisional application No. 62/130,128, filed on Mar. 9, 2015.
(60) Provisional application No. 62/138,637, filed on Mar. 26, 2015.

(51) Int. Cl. A63B 60/14; A63B 59/70; A63B 60/50; B25G 1/10

(52) U.S. Cl. CPC A63B 60/14; B25G 1/102; A63B 59/70; A63B 60/50; A63B 2209/00

(57) ABSTRACT

Disclosed is apparatus for use with a sports stick of the type that has a portion which, in use, is typically covered with a grippable material. The apparatus includes a body of heat shrink material, the body being adapted to receive the portion in spaced-relation and further adapted, upon receipt of heat and when in receipt of the portion, to shrink to a working size that surrounds the portion in close-fitting relation. The body can be provided with features that, at least when the body is shrunk to the working size, renders the body grippable. The features can be apertures.

### CROSS-REFERENCE TO RELATED APPLICATIONS

This application is a continuation-in-part application of International PCT Patent Application No. PCT/CA2016/050255 filed Mar. 9, 2016, which claims priority to U.S. Provisional Patent Application Ser. No. 62/130,128, filed Mar. 9, 2015 and U.S. Provisional Patent Application Ser. No. 62/138,637, filed Mar. 26, 2015, which are each herein incorporated by reference.

### BACKGROUND OF THE INVENTION

### 1. Field of The Invention

The invention relates to the field of sport.

### 2. Description of the Related Art

It is well known to wrap tape around the handle and blade of hockey sticks to provide, on the blade, a puck-gripping surface, and on the handle, a manually-grippable handle.

### SUMMARY OF THE INVENTION

Forming one aspect of the invention is apparatus for use with a sports stick of the type that has a portion which, in use, is typically covered with a grippable material, the apparatus comprising: a body of heat shrink material, the body being adapted to receive the portion in spaced-relation and further adapted, upon receipt of heat and when in receipt of the portion, to shrink to a working size that surrounds the portion in close-fitting relation.

According to another aspect, the body can be provided with features that, at least when the body is shrunk to the working size, renders the body grippable.

According to another aspect, the features can be apertures.

According to another aspect: the body can be a sleeve having a generally rectangular cross-section, the sleeve having generally planar side walls and top and bottom walls; and the apertures can be spaced apart from one another about 4.7 mm, each having a diameter of about 3.5 mm.

Forming another aspect of the invention is a kit for use with a hockey stick, the kit comprising: the apparatus, adapted for use with the blade of the hockey stick; the apparatus, adapted for use with the end of the hockey stick opposite the blade; a ring having a relatively large external diameter and adapted to engage the end of the stick opposite the blade in gripping relation; and a plurality of rings having a relatively small external diameter and adapter to engage the end of the stick opposite the blade in gripping relation.

Advantages, features and characteristics of the invention will become apparent upon review of the following detailed description and the accompanying drawings, the latter being briefly described hereinafter.

### BRIEF DESCRIPTION OF THE DRAWINGS

FIG. 1 is a side view of apparatus constructed according to an exemplary embodiment of the invention;

FIG. 2 is an end view of the structure of FIG. 1;

FIG. 3 is a view of the structure of FIG. 1 in use;

FIG. 4 is a view of a system constructed according to another exemplary embodiment of the invention;

FIG. 5 is a side view of the structure of encircled area 5 of FIG. 4;

FIG. 6 is an end view of the structure of FIG. 5;

FIG. 7A is a side view of the structure of encircled area 7 of FIG. 4;

FIG. 7B is an end view of the structure of FIG. 7;

FIG. 8 is a side view of the structure of encircled area 9 of FIG. 9;

FIG. 9 is an end view of the structure of encircled area 9 of FIG. 4;

FIG. 10 is a view of the structure FIG. 4 in use;

FIG. 11 is a view similar to FIG. 1 of another embodiment of the invention;

FIG. 12 is an end view of the structure of FIG. 11;

FIG. 13 is a view similar to FIG. 4 of another embodiment of the invention;

FIG. 14 is a side view of encircled area 14 of FIG. 13;

FIG. 15 is an end view of the structure of FIG. 14;

FIG. 16 is a view similar to FIG. 1 of another embodiment of the invention;

FIG. 17 is an end view of the structure of FIG. 16;

FIG. 18 is a perspective view of another embodiment of the invention;

FIG. 19 is a side view of the structure of FIG. 18;

FIG. 20 is an end view of the structure of FIG. 19;

FIG. 21 is a view similar to FIG. 1 of another embodiment of the invention;

FIG. 22 is an end view of the structure of FIG. 21;

FIG. 23 is a perspective view of another embodiment of the invention;

FIG. 24 is a perspective view of another embodiment of the invention;

FIG. 25 is a side view of the structure of FIG. 24;

FIG. 26 is an end view of the structure of FIG. 25;

FIG. 27 is a view of another embodiment of the invention;

FIG. 28 is a view of the structure of encircled area 28 of FIG. 27;

FIG. 29 is an end view of the structure of FIG. 28;

FIG. 30 is a view of the structure of FIG. 27 in use;

FIG. 31 is a view similar to FIG. 10 of another embodiment;

FIG. 32 is a view of the structure of FIG. 31 from another vantage point;

FIG. 33 is a view of the structure of FIG. 31 from another vantage point;

FIG. 34 is a view of the structure of FIG. 31 from another vantage point;

FIG. 35 is a view similar to FIG. 10 of another embodiment;

FIG. 36 is a view of the structure of FIG. 35 from another vantage point;

FIG. 37 is a view of the structure of FIG. 35 from another vantage point;

FIG. 38 is a view of the structure of FIG. 35 from another vantage point;

FIG. 39 is a view similar to FIG. 10 of another embodiment;

FIG. 40 is a view of the structure of FIG. 39 from another vantage point;

FIG. 41 is a view of the structure of FIG. 39 from another vantage point;

FIG. 42 is a view of the structure of FIG. 39 from another vantage point;

FIG. 43 is a view similar to FIG. 3 of another embodiment;

FIG. 44 is a view of the structure of FIG. 43 from another vantage point;

FIG. 45 is a view of the structure of FIG. 43 from another vantage point;

FIG. 46 is a view similar to FIG. 3 of another embodiment;

FIG. 47 is a view of the structure of FIG. 46 from another vantage point;

FIG. 48 is a view of the structure of FIG. 46 from another vantage point;

FIG. 49 is a view similar to FIG. 3 of another embodiment;

FIG. 50 is a view of the structure of FIG. 49 from another vantage point;

FIG. 51 is a view of the structure of FIG. 49 from another vantage point;

FIG. 52 is a view similar to FIG. 3 of another embodiment;

FIG. 53 is a view of the structure of FIG. 52 from another vantage point;

FIG. 54 is a view of the structure of FIG. 52 from another vantage point;

FIG. 55 is a view similar to the view shown in encircled area 5 of FIG. 4 of another embodiment;

FIG. 56 is a view of the structure of FIG. 55 from another vantage point;

FIG. 57 is a view of the structure of FIG. 55 from another vantage point;

FIG. 58 is a view of the structure of FIG. 55 from another vantage point;

FIG. 59 is a view of the structure of FIG. 55 from another vantage point;

FIG. 60 is an enlarged view of encircled area 60 of FIG. 55;

FIG. 61 is a view similar to the view shown in encircled area 5 of FIG. 4 of another embodiment; the broken lines indicate indeterminate length;

FIG. 62 is a view of the structure of FIG. 61 from another vantage point;

FIG. 63 is a view of the structure of FIG. 61 from another vantage point;

FIG. 64 is a view of the structure of FIG. 61 from another vantage point;

FIG. 65 is a view of the structure of FIG. 61 from another vantage point;

FIG. 66 is an enlarged view of encircled area 66 of FIG. 61;

FIG. 67 is a view similar to the view shown in encircled area 5 of FIG. 4 of another embodiment;

FIG. 68 is a view of the structure of FIG. 67 from another vantage point;

FIG. 69 is a view of the structure of FIG. 67 from another vantage point;

FIG. 70 is a view of the structure of FIG. 67 from another vantage point;

FIG. 71 is a view of the structure of FIG. 67 from another vantage point;

FIG. 72 is an enlarged view of encircled area 72 of FIG. 67;

FIG. 73 is a view similar to the view shown in encircled area 5 of FIG. 4 of another embodiment;

FIG. 74 is a view of the structure of FIG. 73 from another vantage point;

FIG. 75 is a view of the structure of FIG. 73 from another vantage point;

FIG. 76 is a view of the structure of FIG. 73 from another vantage point;

FIG. 77 is a view of the structure of FIG. 73 from another vantage point;

FIG. 78 is an enlarged view of encircled area 78 of FIG. 73;

FIG. 79 is a view similar to the view shown in encircled area 5 of FIG. 4 of another embodiment;

FIG. 80 is a view of the structure of FIG. 79 from another vantage point;

FIG. 81 is a view of the structure of FIG. 79 from another vantage point;

FIG. 82 is a view of the structure of FIG. 79 from another vantage point;

FIG. 83 is a view of the structure of FIG. 79 from another vantage point;

FIG. 84 is an enlarged view of encircled area 79 of FIG. 79;

FIG. 85 is a perspective view of another embodiment;

FIG. 86 is an end dimensioned view of the structure of FIG. 85;

FIG. 87 is a side dimensioned view of the structure of FIG. 85;

FIG. 88 is a side view of the structure of FIG. 85 as it appears in use; and

FIG. 89 is perspective view of the structure of FIG. 85 as it appears in use.

### DETAILED DESCRIPTION OF THE INVENTION

The embodiments discussed herein are merely illustrative of specific manners in which to make and use the invention and are not to be interpreted as limiting the scope.

While the invention has been described with a certain degree of particularity, it is to be noted that many modifications may be made in the details of the invention's construction and the arrangement of its components without departing from the scope of this disclosure. It is understood that the invention is not limited to the embodiments set forth herein for purposes of exemplification.

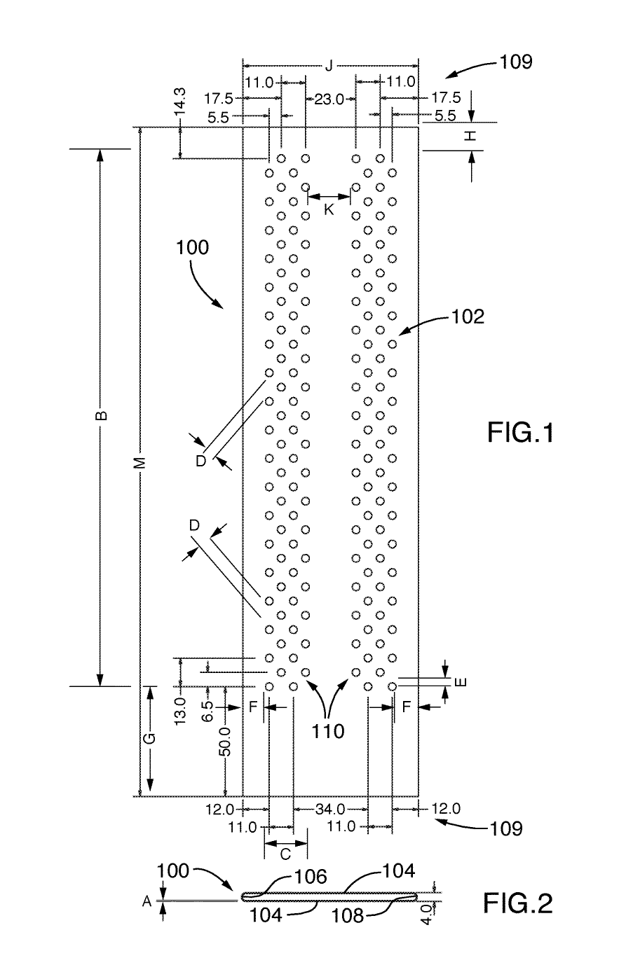

Reference is now made to FIGS. 1-3 wherein an exemplary embodiment of the invention is illustrated and will be seen to include a body 100 of heat shrink material having features 102 in the form of apertures.

The body 100 is a sleeve having a generally rectangular cross-section, the sleeve having generally planar side walls 104, top 106 and bottom 108 walls and ends 109. The perforations 102 are disposed in two groups 110 on each side wall. All of the foregoing is characterized in that:
the sleeve has a wall thickness A of about 1.3 mm
the groups 110 are generally rectangular in shape, each having a length B of about 244 mm, a height C of about 20 mm and consisting of about 72 apertures
the apertures 102 are spaced apart from one another a distance D of about 4.7 mm and each has a diameter E of about 3.5 mm
the groups 110 are spaced from the top 106 and bottom 108 walls a distance F of about 10.25 mm and from the sleeve ends by distances G and H of about 48.25 mm and 12.75 mm
the side walls have a height J of about 80 mm and the groups are spaced apart from one another a distance K of about 19.5 mm
the sleeve has a length M of about 305 mm
the material is PVC heat shrink material having a 2:1 shrink ratio, 10% laterally of the type sold under Part No. HS-105-2 by Insultab

The foregoing results in a structure that has surprising utility in combination with the blade portion of a hockey stick.

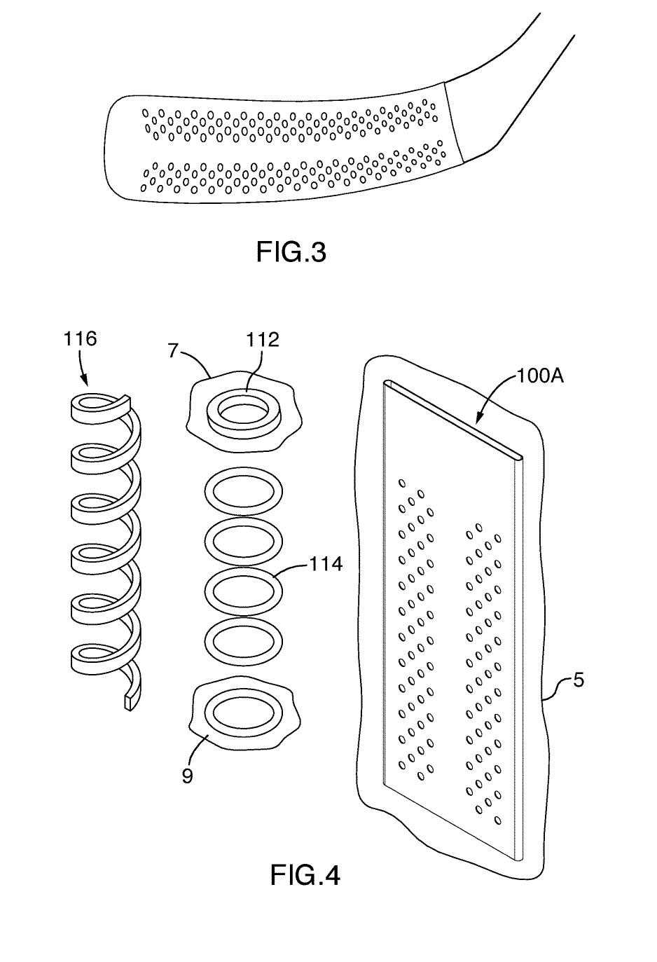

More particularly, the body is adapted:
to receive the blade portion in spaced-relation
upon receipt of heat, by a heat gun or boiling water, and when in receipt of the blade portion, to shrink to a working size that surrounds the portion in close-fitting relation, as shown in FIG. 3
when shrunk to the working size, to be grippable of pucks, by virtue of the apertures

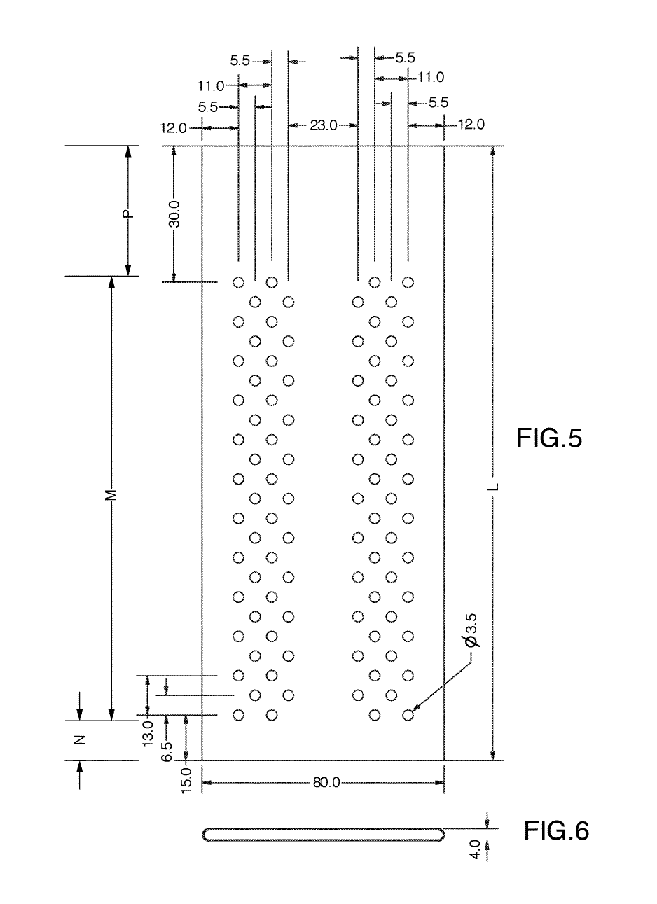

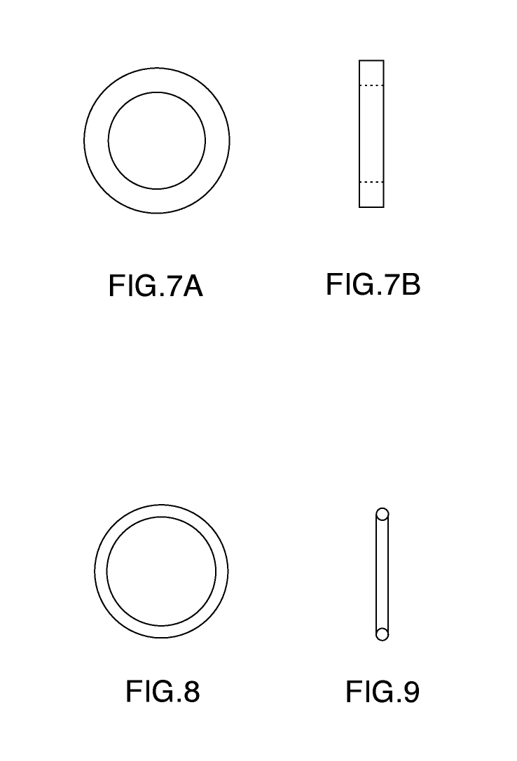

It should be noted that the blades of Junior, Intermediate and Senior sticks range from 10″ to 11″ in length, and the sleeve of FIGS. 1,2 fits all. Another embodiment of the invention is shown in FIGS. 4-10 and will be seen to include an alternate sleeve 100A, a flat ring 112, a plurality of o-rings 114 and a length of foam tape 116. This sleeve 100A differs from the sleeve of FIGS. 1 and 2 in that (i) the sleeve has a length L of about 180 mm (ii) each group has a length M of about 138.5 mm, consists of about 46 apertures and is spaced from the ends by distances N, P of about 13.25 mmm and 28.25 mmm, respectively. Each o-ring 114 has a 1″ ID and a fractional width of ⅛″. The flat ring 112 ring has an ID of 31.3 mm, an OD of 44 mm and a thickness of 6.35 mm. The foam tape 116 is 20″ long, 0.25″ wide and 0.125″ thick and has an adhesive back covered with a release strip, not shown, which can be removed to expose the adhesive. This structure functions in a generally similar manner to that of FIG. 1,2, but is used to form a grip.

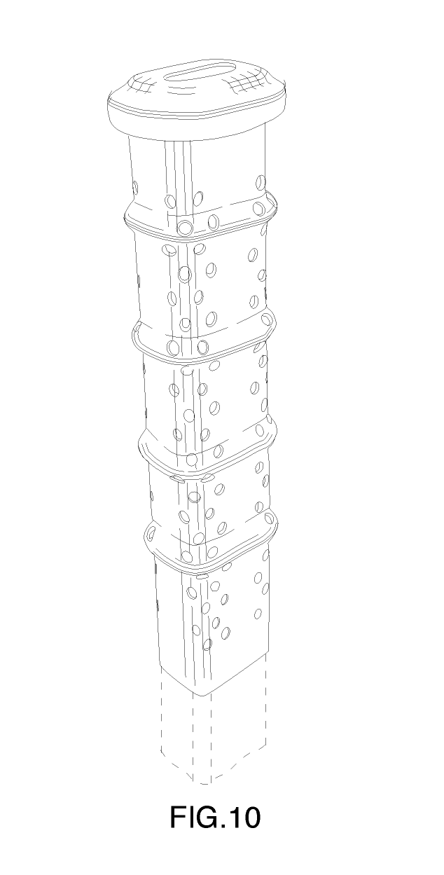

To form a grip as shown in FIG. 10, one:
places the o-rings in spaced relation to one another upon the end of the stick furthest the blade
places the flat ring on the handle end
places the sleeve over the o-rings and flat ring
applies heat to the sleeve, to shrink the sleeve to a working size that surrounds the portion in close-fitting relation.

Again, the apertures, in combination with the relief provided by the rings, provides a grippable surface, this time for hand receipt.

The sleeve can be used with the spiral tape in place of the rings; to do so, one merely removes the release strip, spirals the foam around the stick and carries out the remainder of the steps above. The sleeve can also be used with neither the foam strip nor the o-rings.

Further variations on the above are also possible.

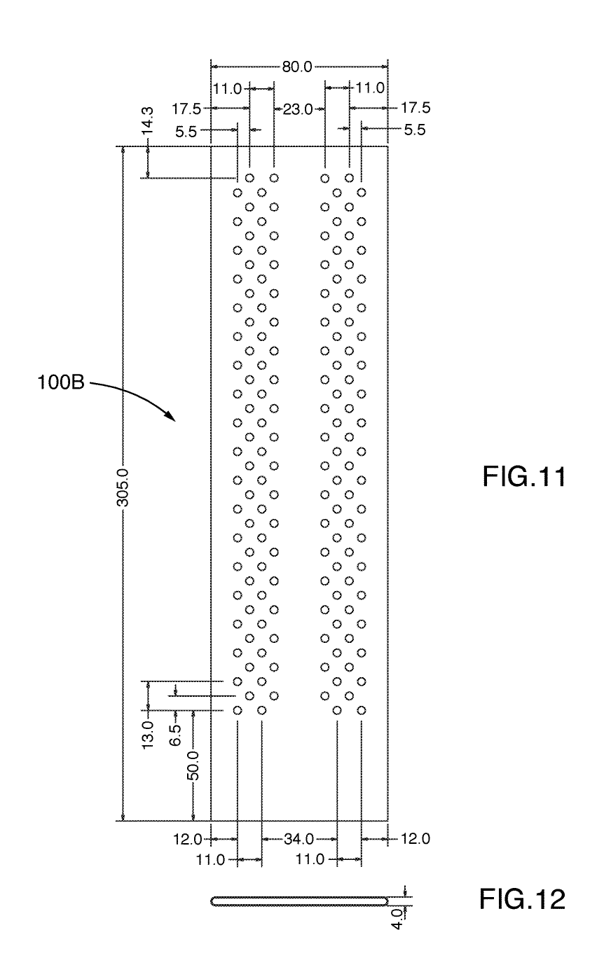

For example, a version of the sleeve for the blade of a hockey stick is shown in FIGS. 11 and 12. This sleeve 100B is identical in dimensions to that of FIGS. 1, 2 but is constructed from polyolefin heat shrink material having a 2:1 shrink ratio, 1% laterally of the type sold under Part No. MHSP-2-0-ILL by Techspan Industries

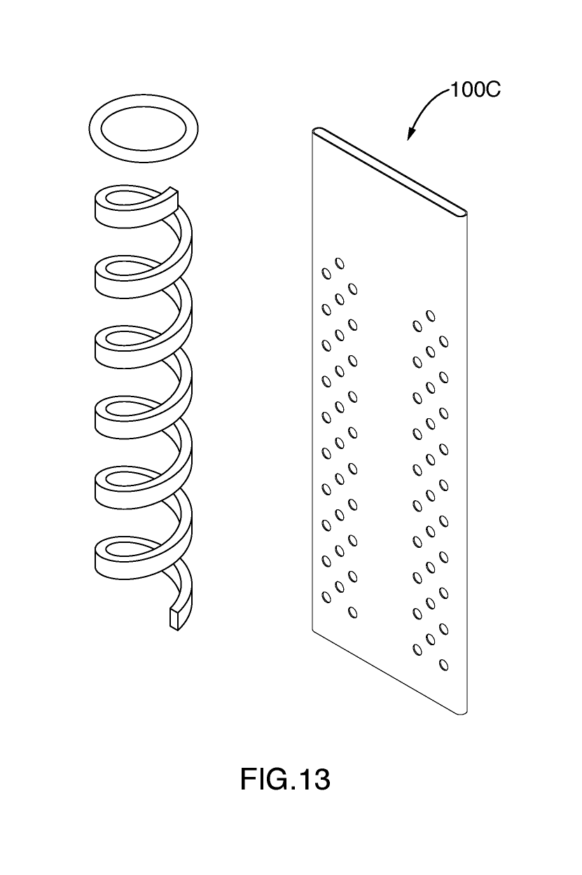

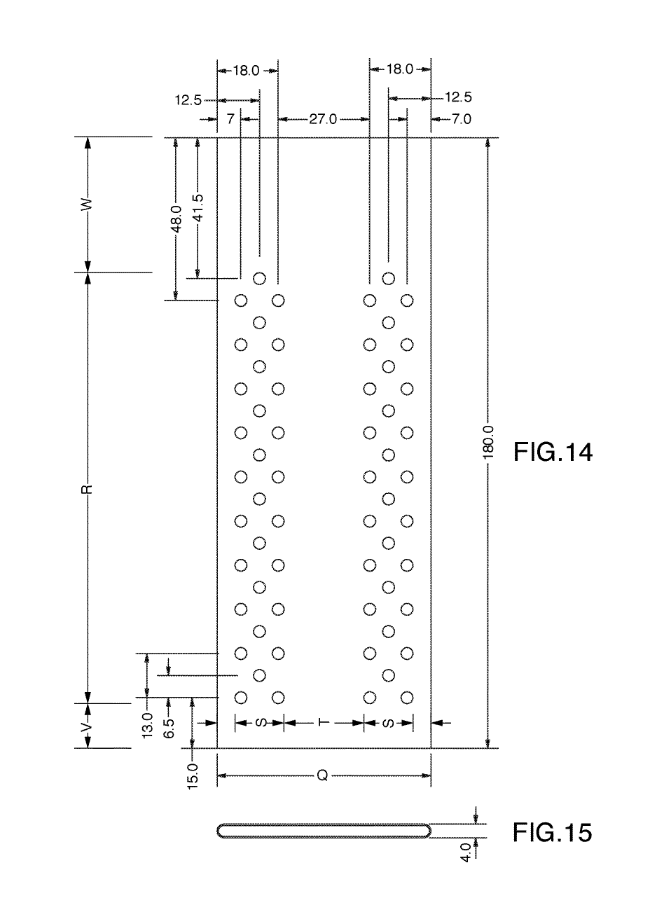

Another version of the kit of FIG. 4 is shown in FIG. 13. The sleeve 100C of this kit, shown in FIGS. 14 and 15, differs in that the side walls have a height Q of about 63 mm, the groups each have a length R of 129 mm and a height S of about 14.5 mm, the groups are spaced apart from one another a distance T of about 23.5 mm and spaced from the ends distances V and W of about 11.25 mm and 39.75 mm, respectively. This sleeve and kit are useful for forming the hand grip of a junior stick.

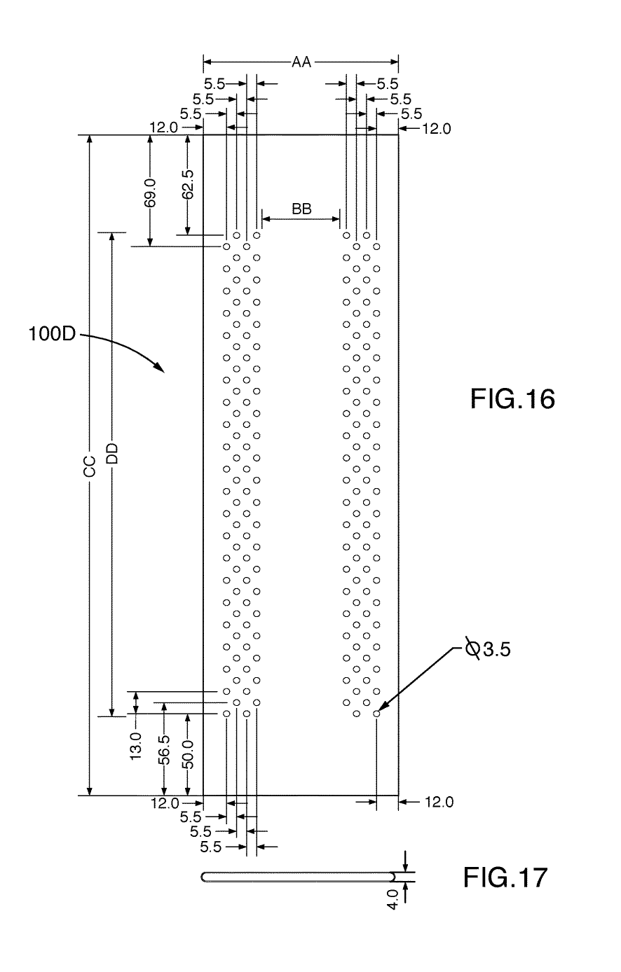

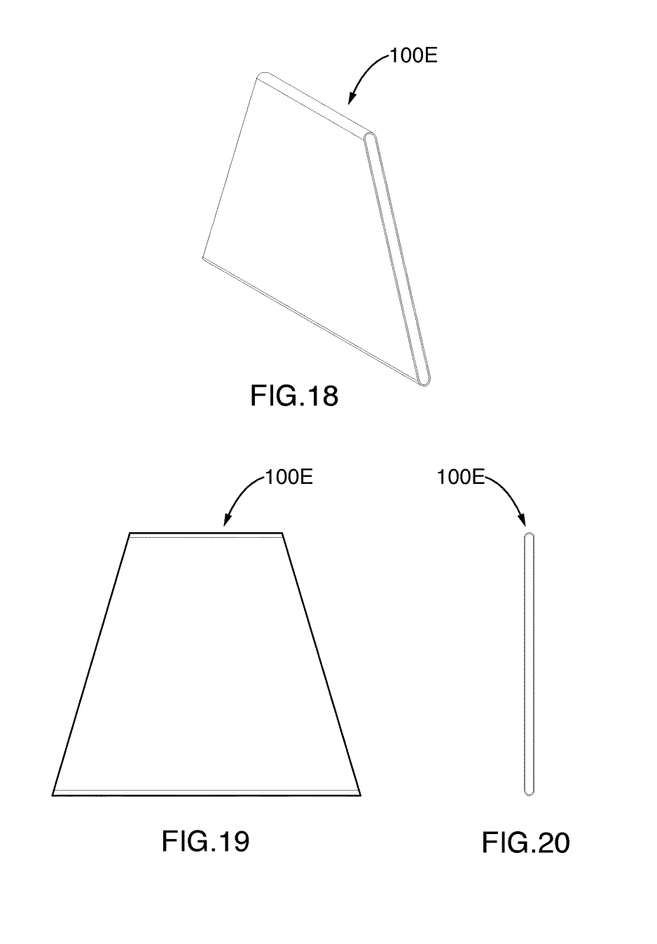

Yet another version of the sleeve is shown in FIGS. 16 and 17. This sleeve 100D differs from that of FIGS. 11 & 12 in that (i) the side walls have a height AA of about 120 mm; (ii) the sleeve has a length CC of about 405 mm; and (iv) the groups each have a length DD of about 296 mm in length, thereby rendering the sleeve suitable for use on the blade of a goalie stick. This sleeve is advantageously used with the sleeve 100E of FIGS. 18-20, which is adapted to fit around the heel of a goalie stick to provide reinforcement. As the heel is not normally used for puck handling, this sleeve lacks perforations.

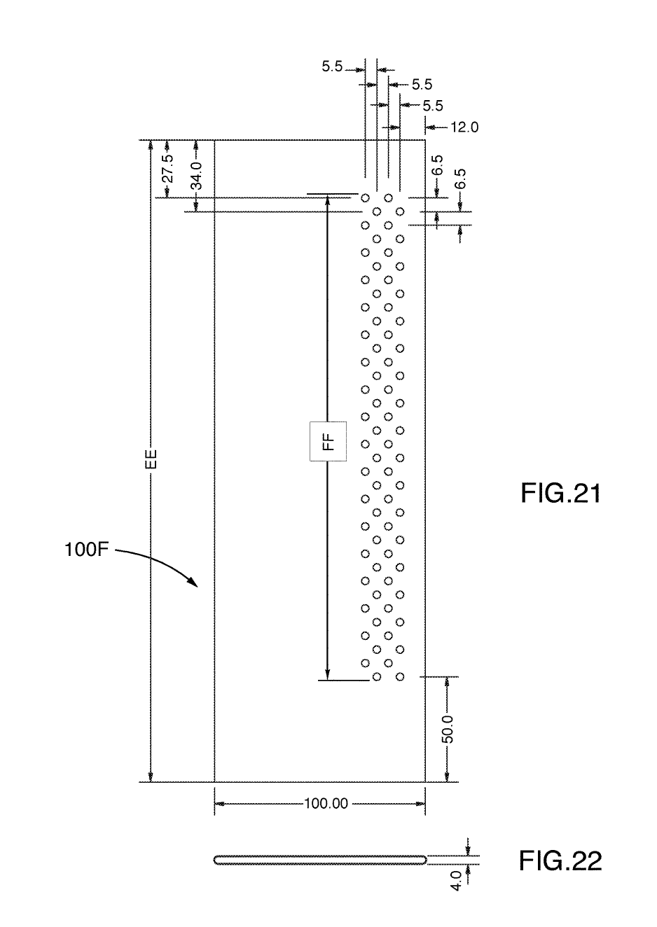

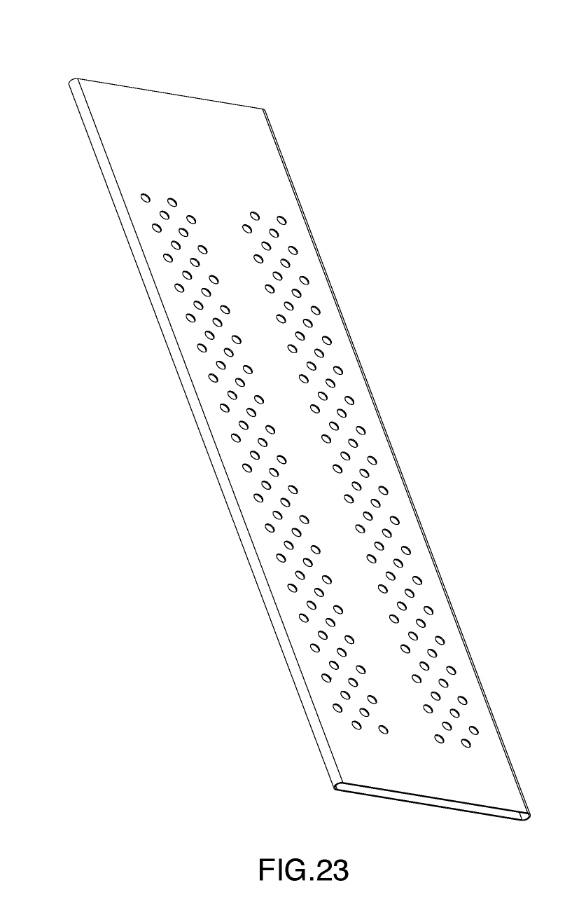

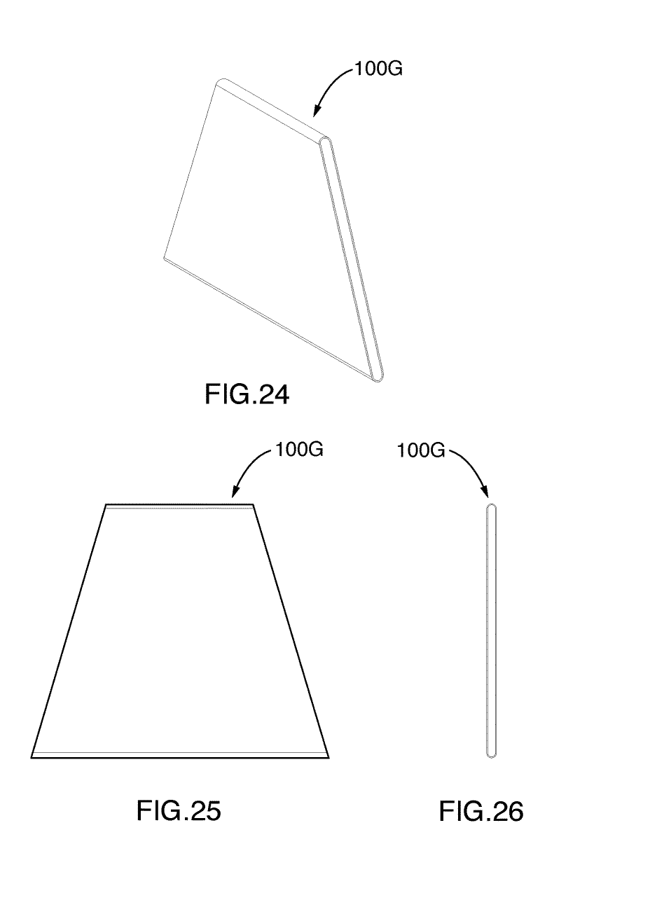

Yet another version of the sleeve is shown in FIGS. 21-23. This sleeve 100F differs from that of FIGS. 16-17 in that (i) the sleeve has a length EE of about 305 mm; (ii) the sleeve is made of PVC heat shrink material, with a2:1 shrink ratio, 10% lateral shrink; and (iii) there is only a single grouping, with a length FF of 251.5 mm. This sleeve can also be used with the sleeve 100G of FIGS. 24-26.

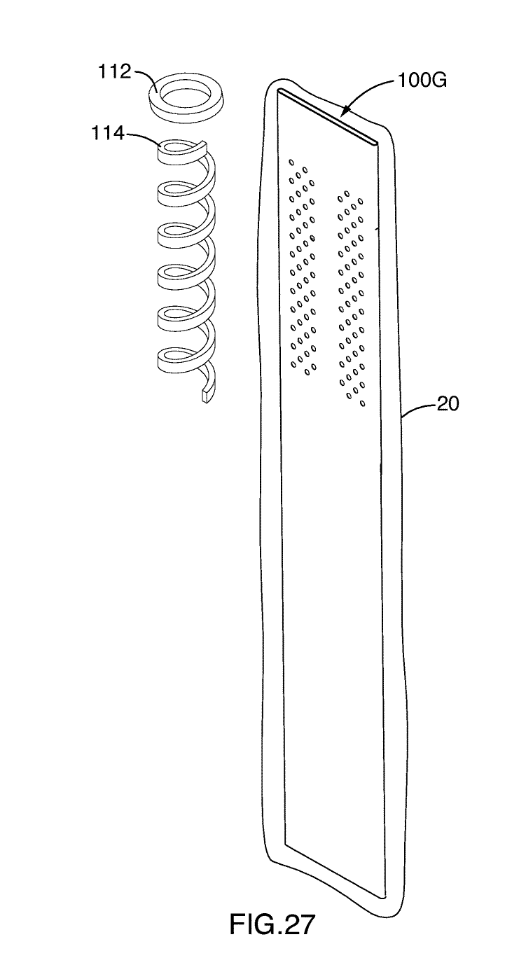

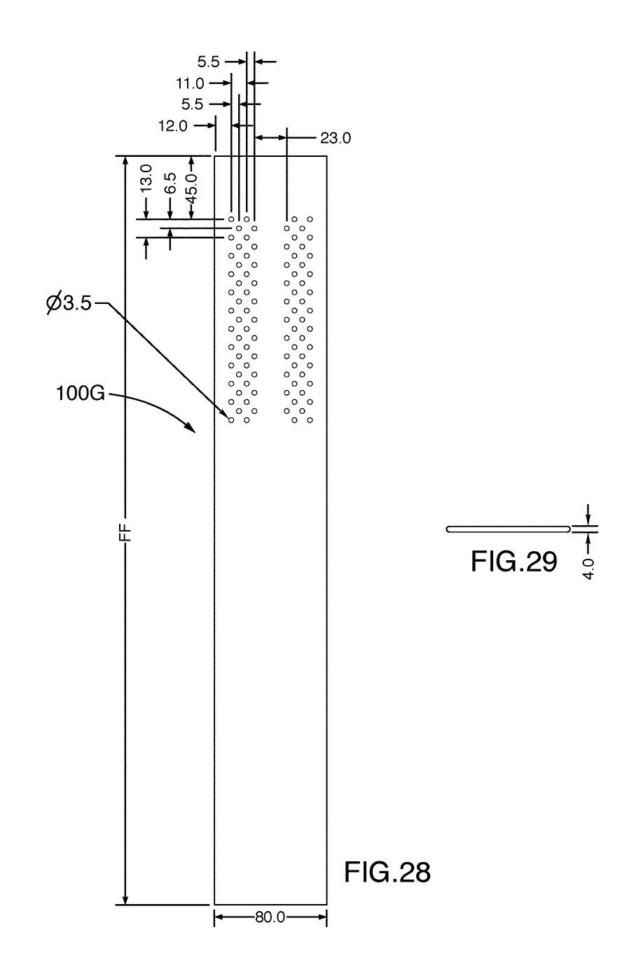

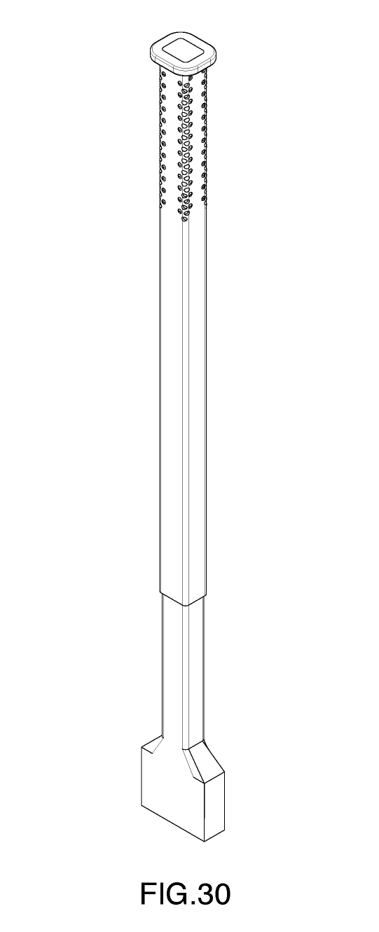

A yet further variation of the sleeve is shown in FIG. 27 and FIG. 28. The sleeve 100G differs in that it has a length FF of about 533 mm, and is useful to form, in combination with another washer and a foam strip, a goalie stick top grip as shown in FIG. 30.

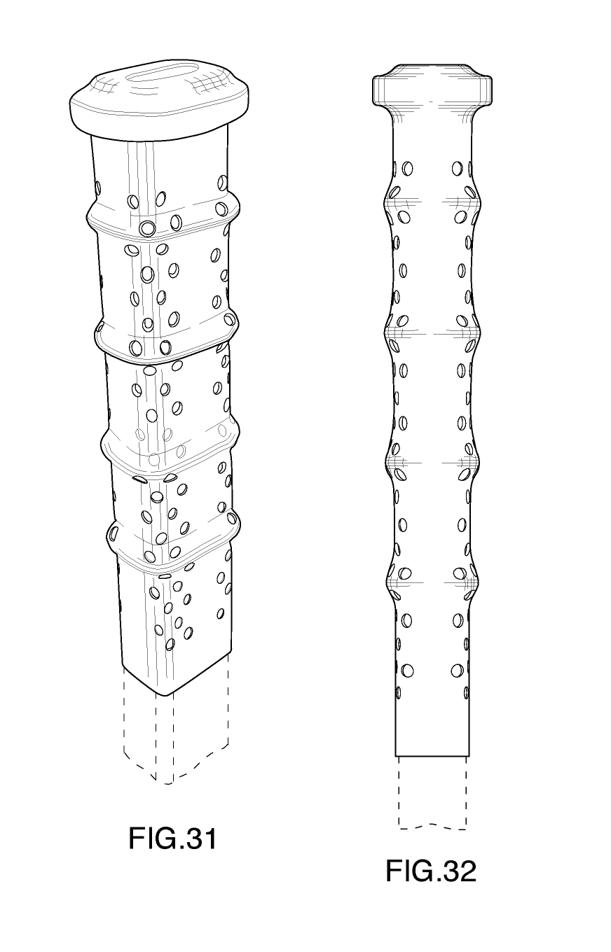

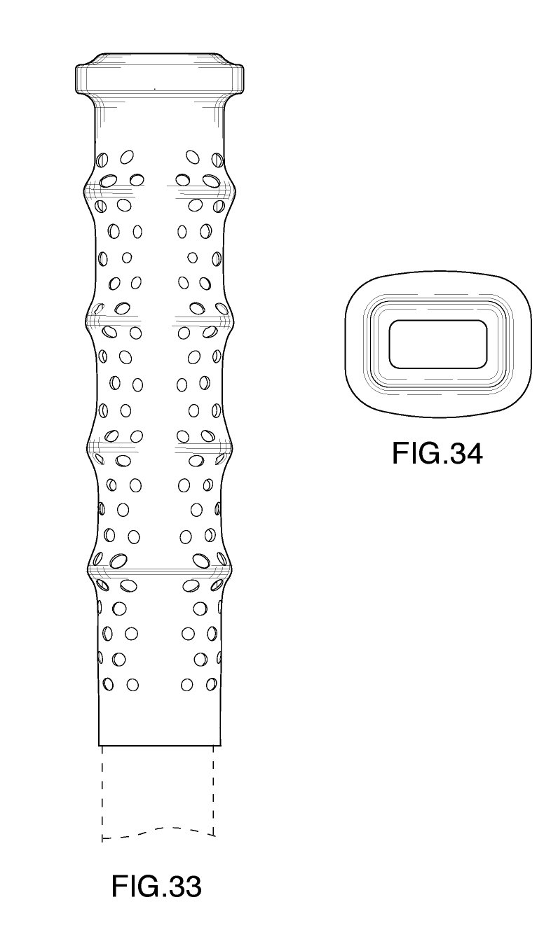

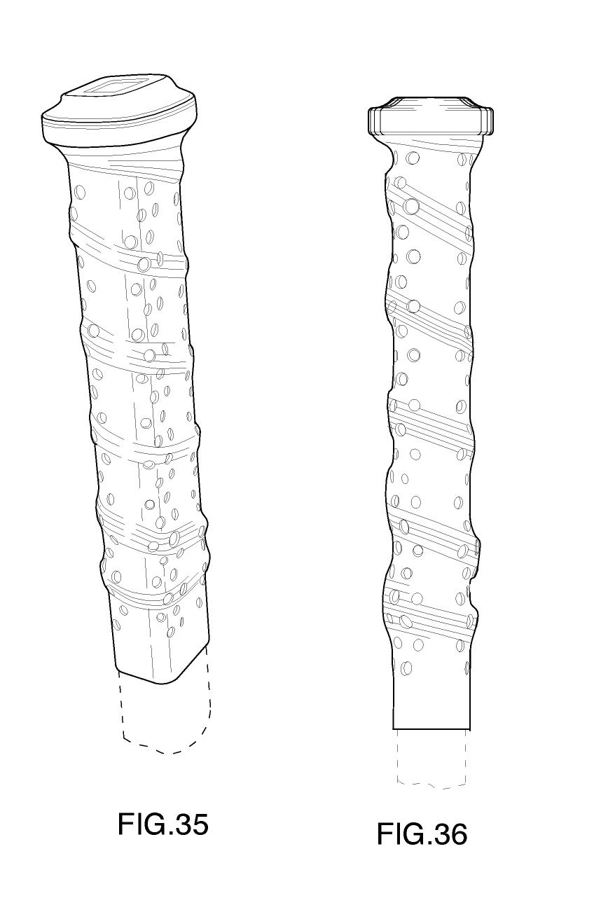

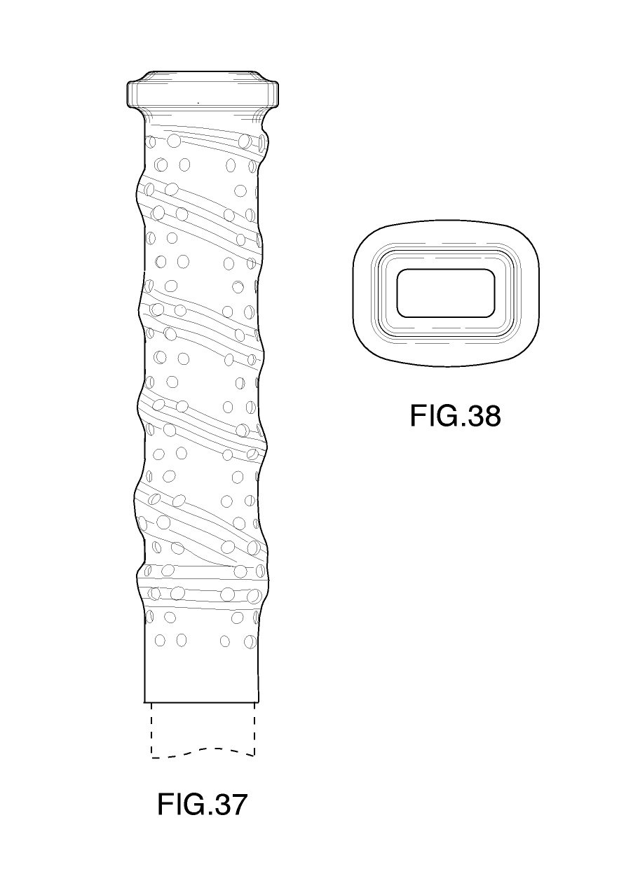

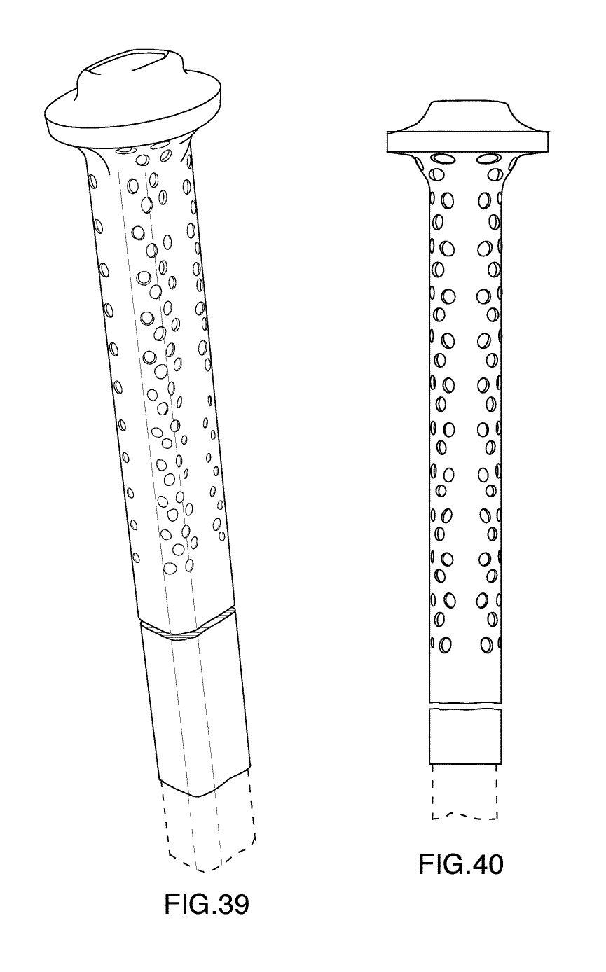

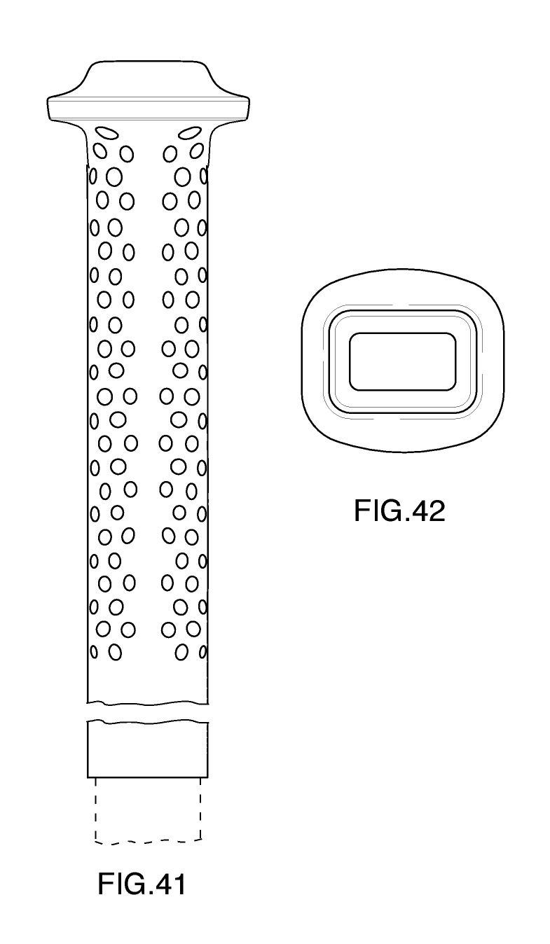

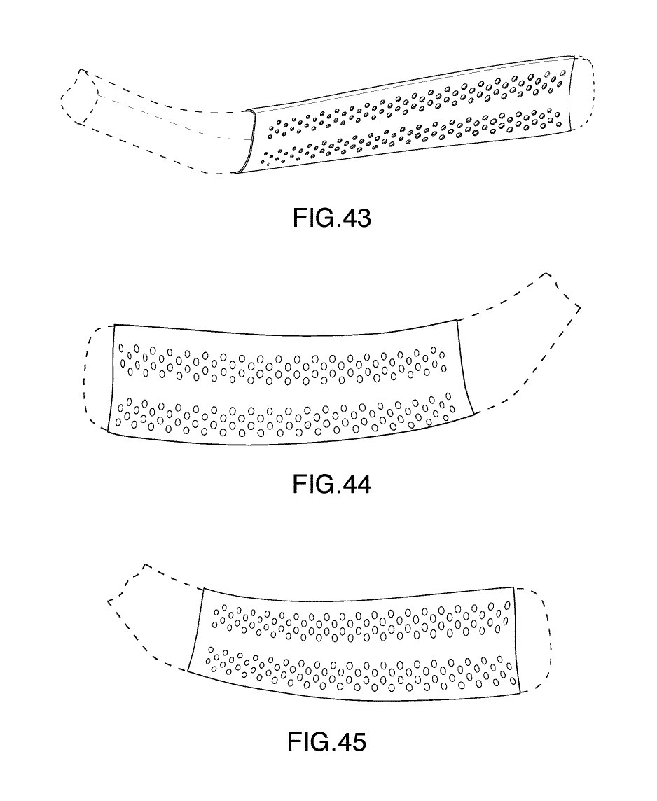

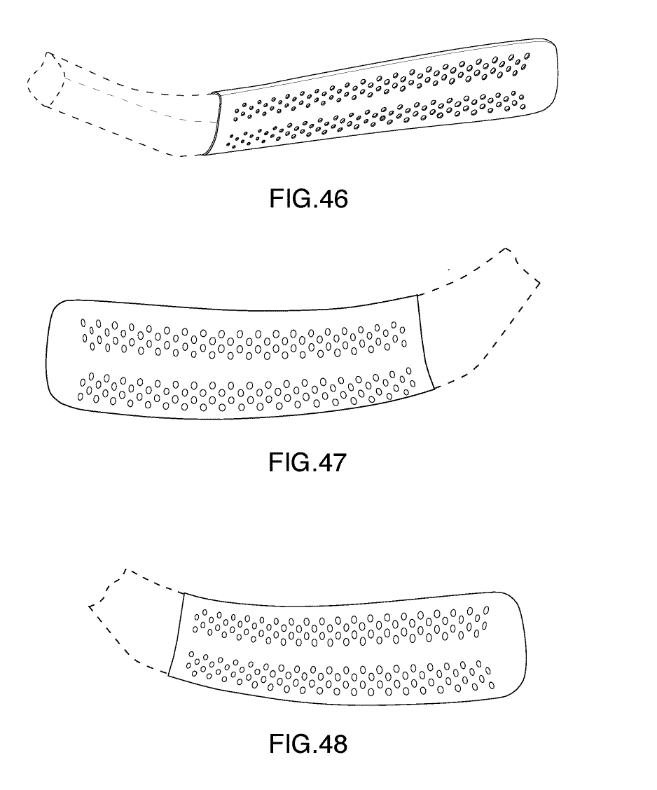

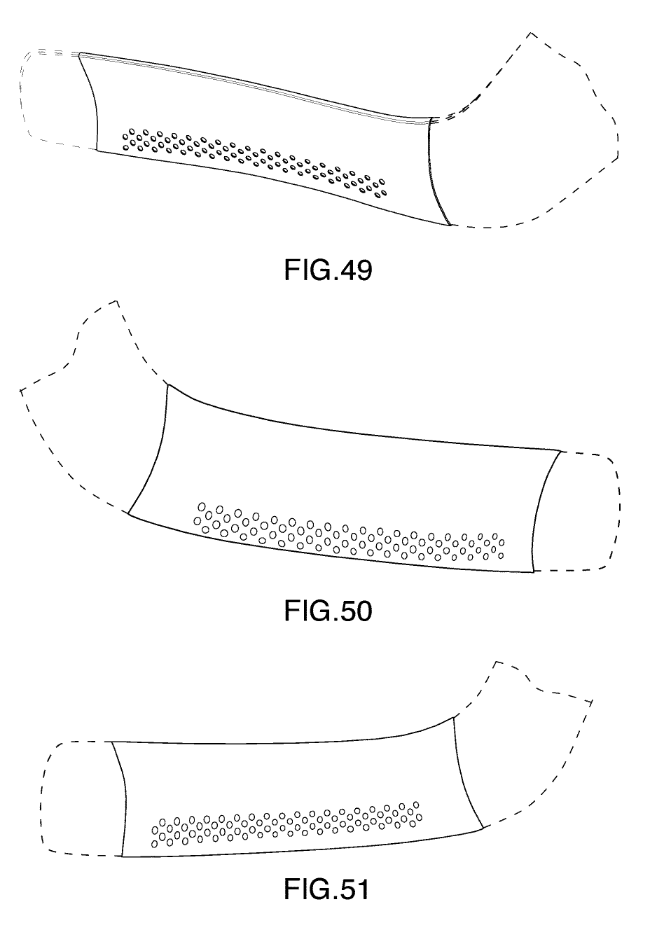

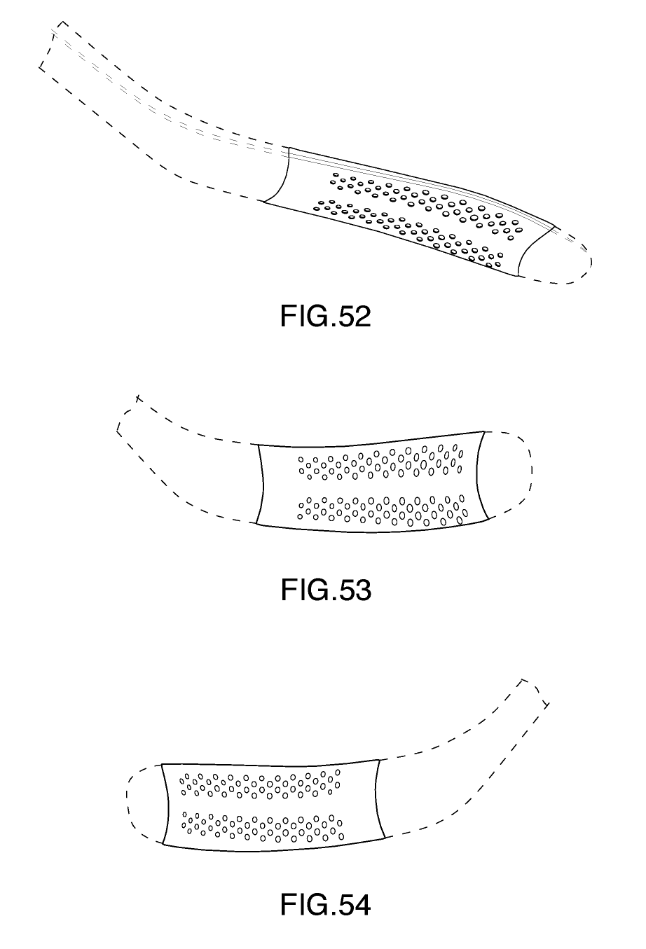

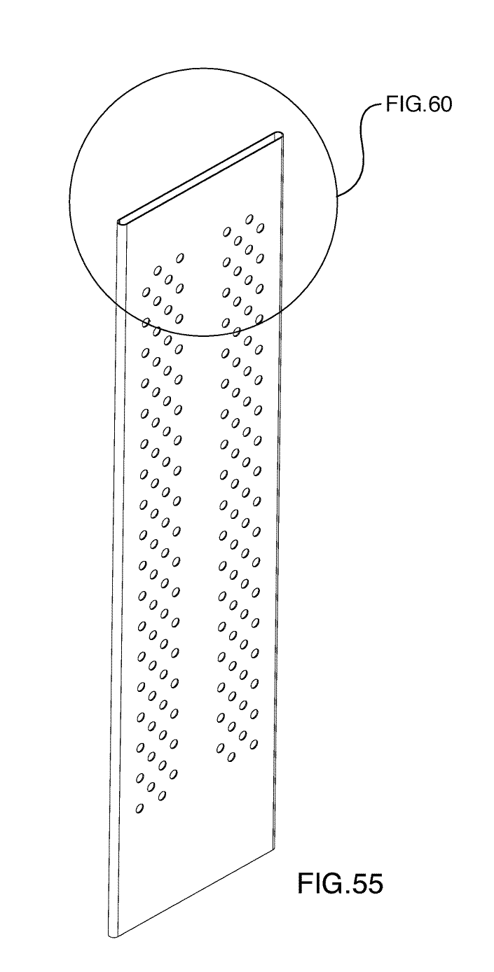

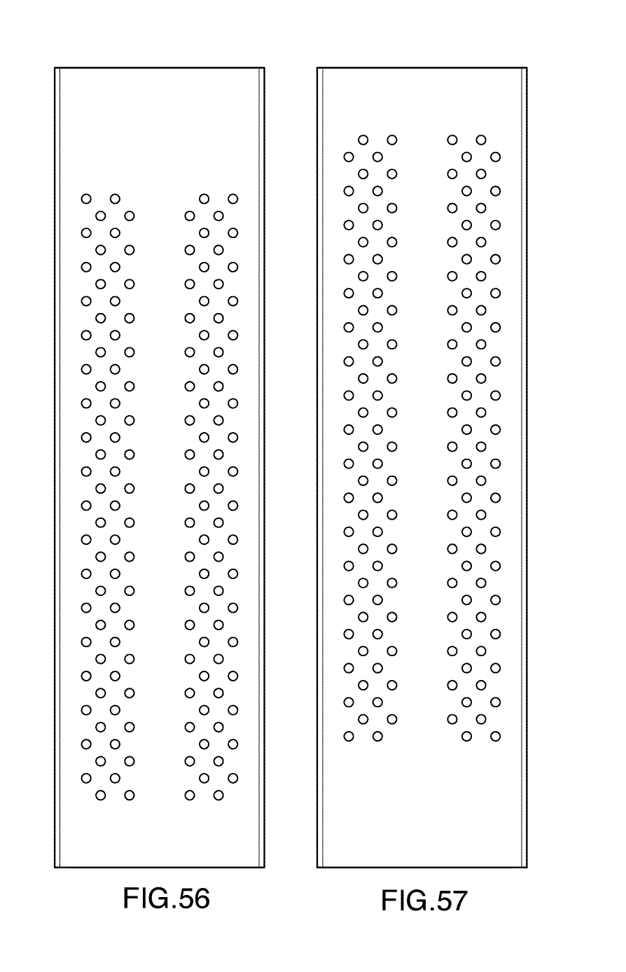

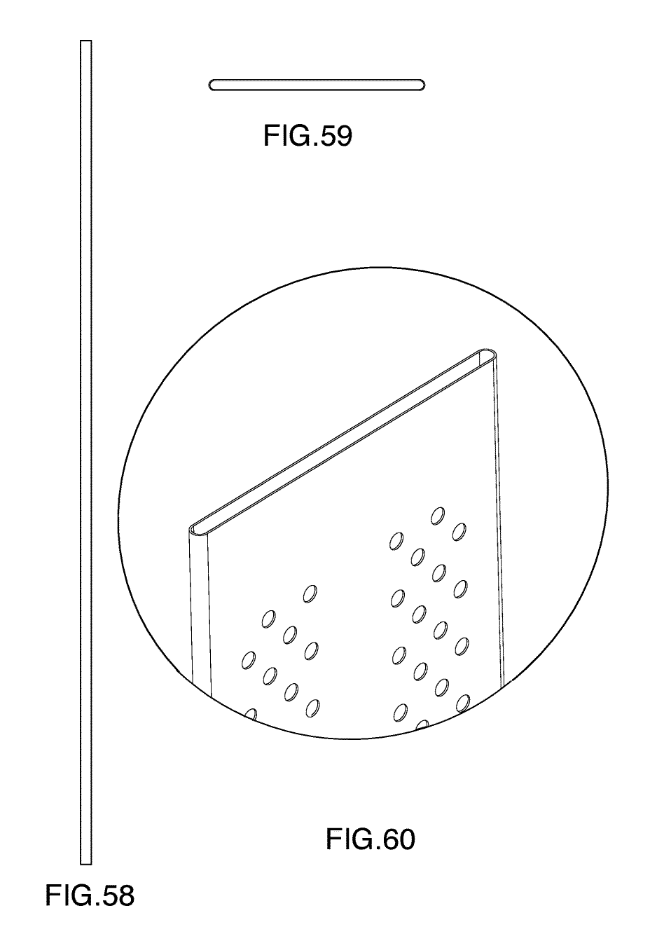

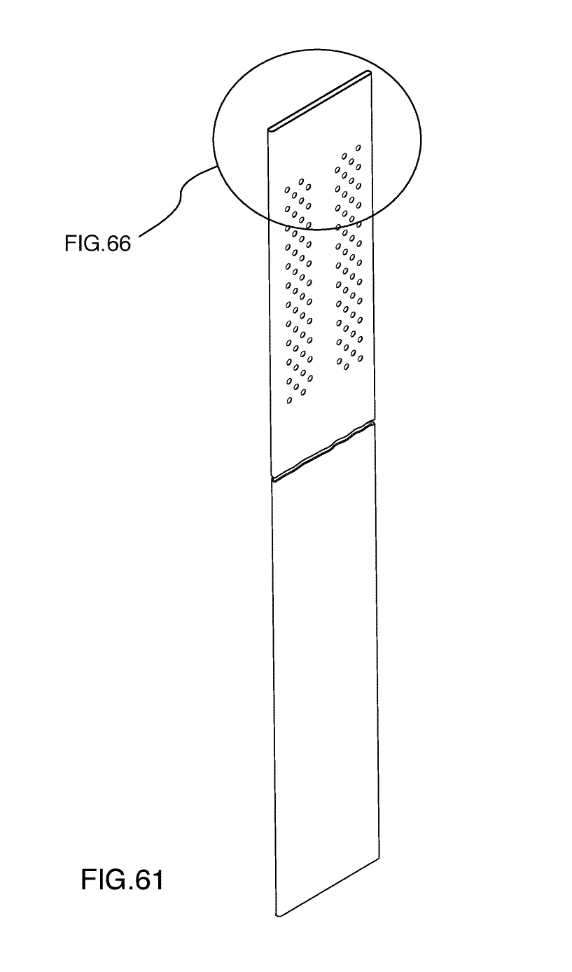

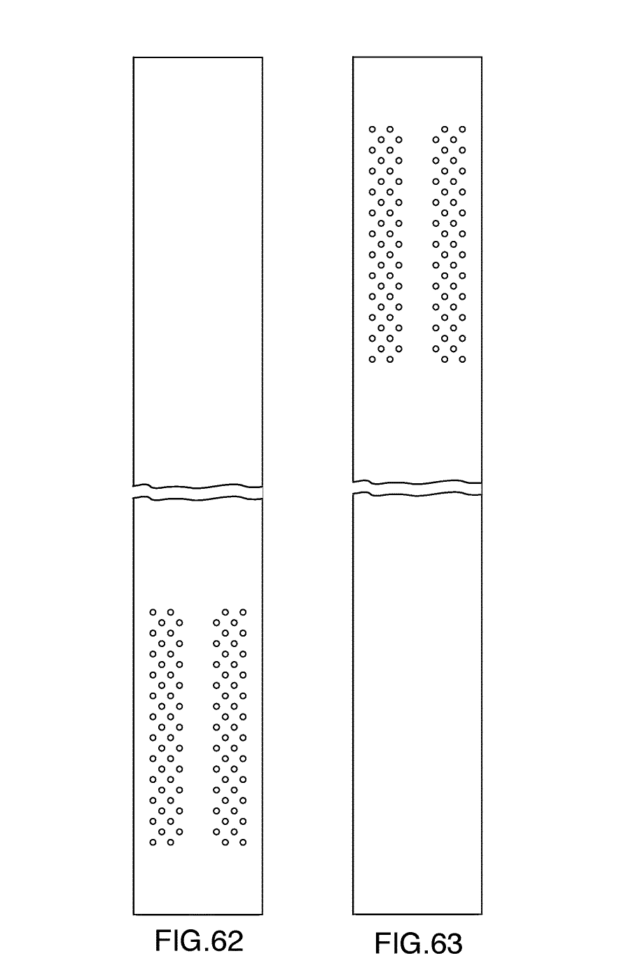

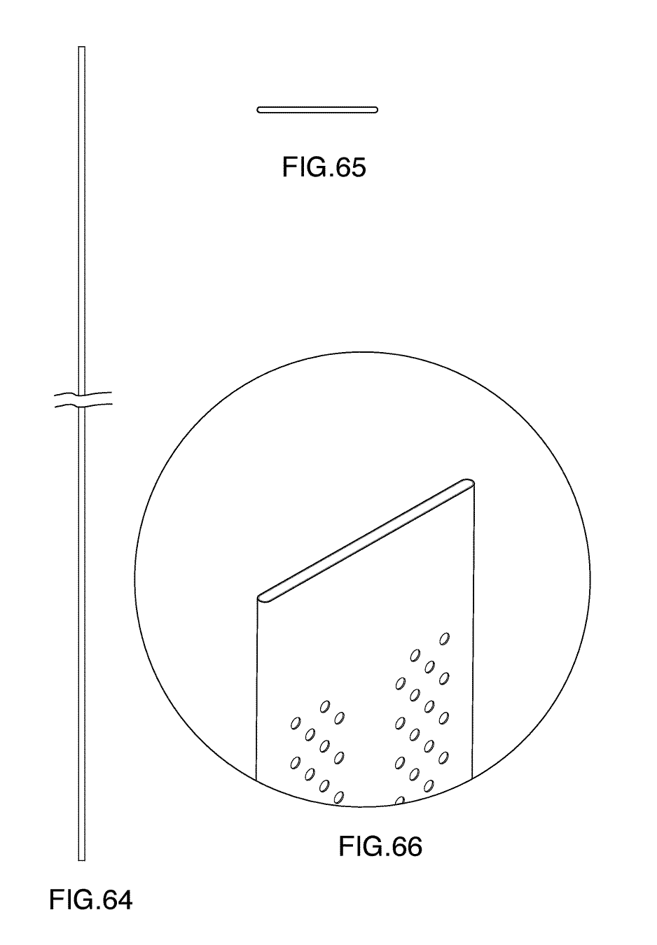

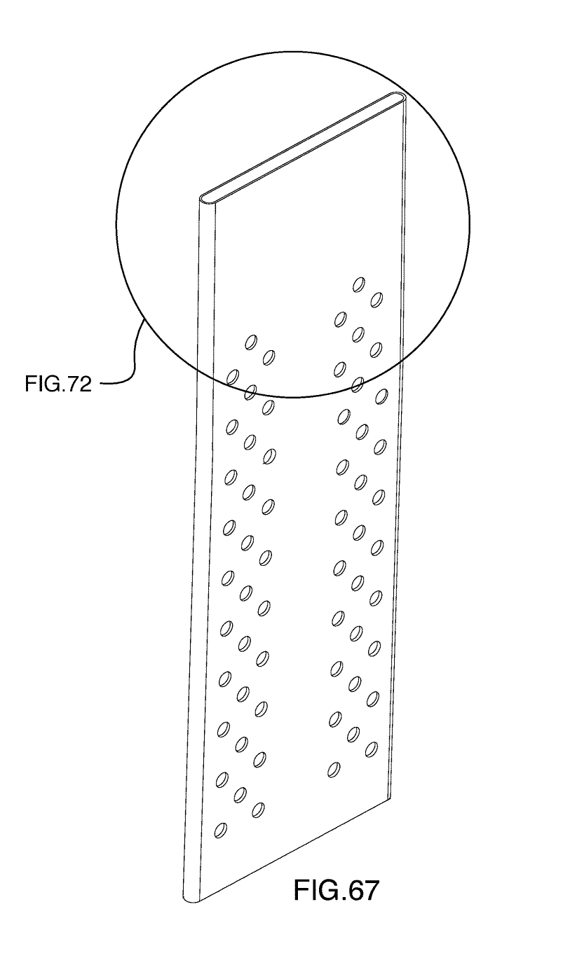

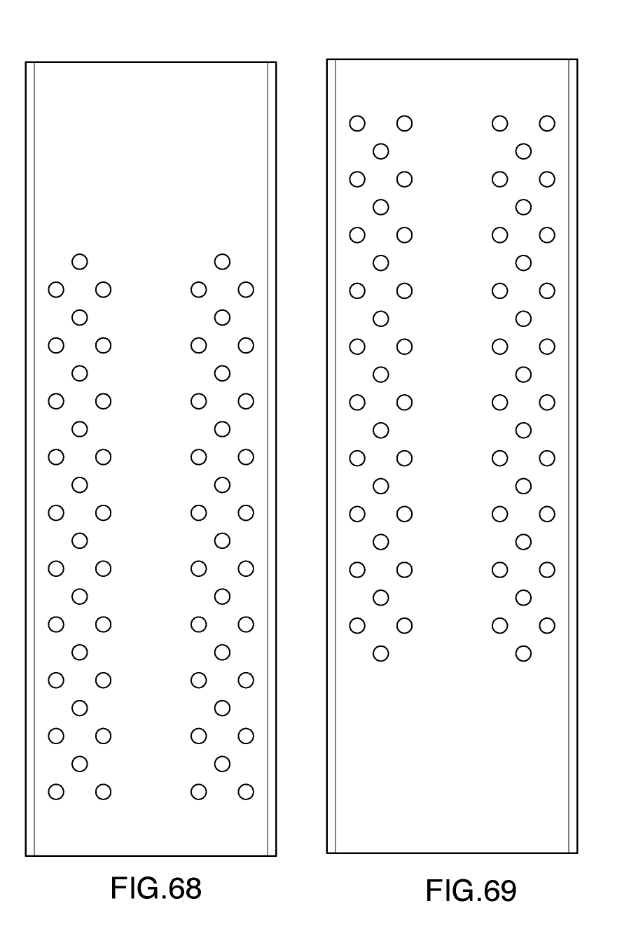

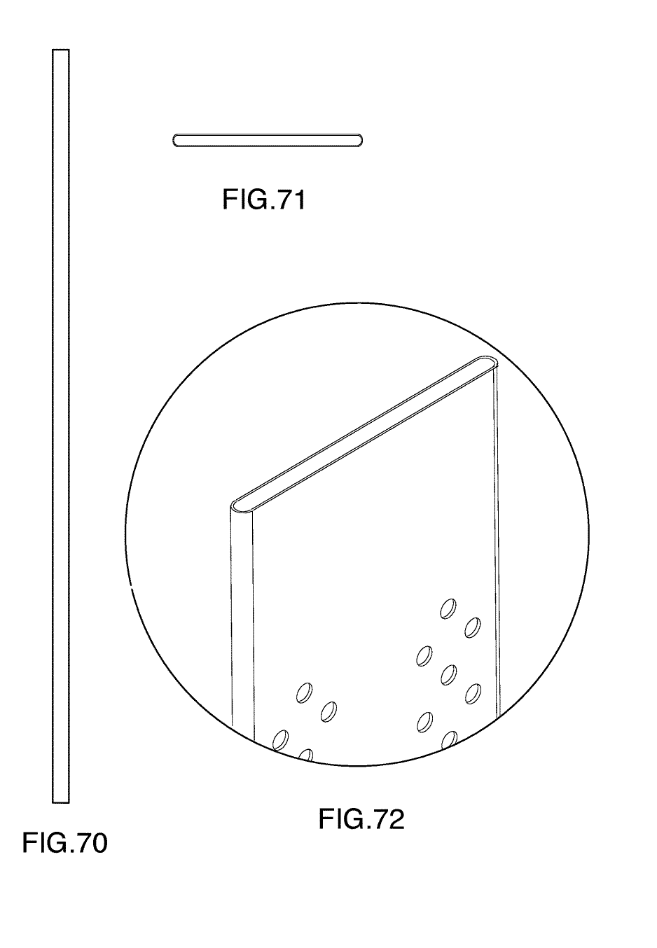

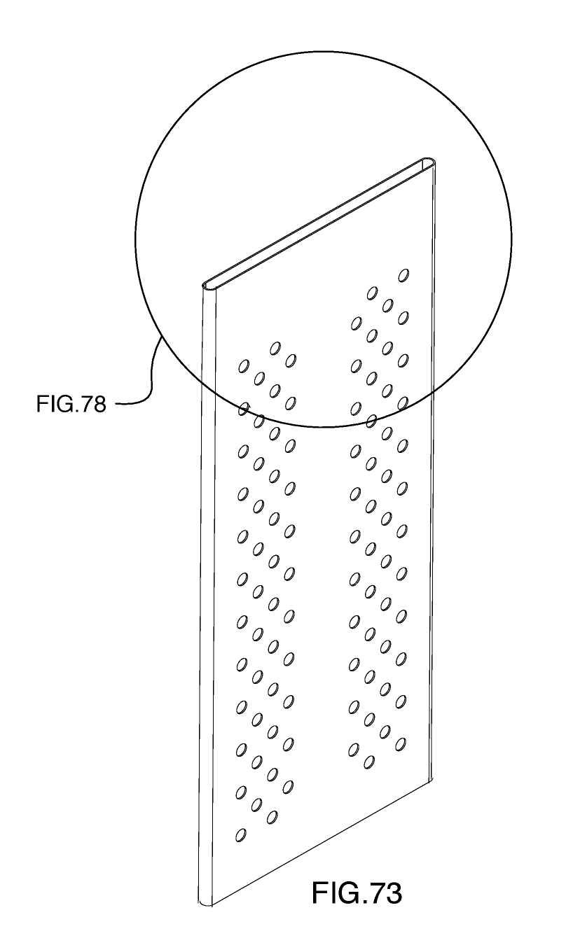

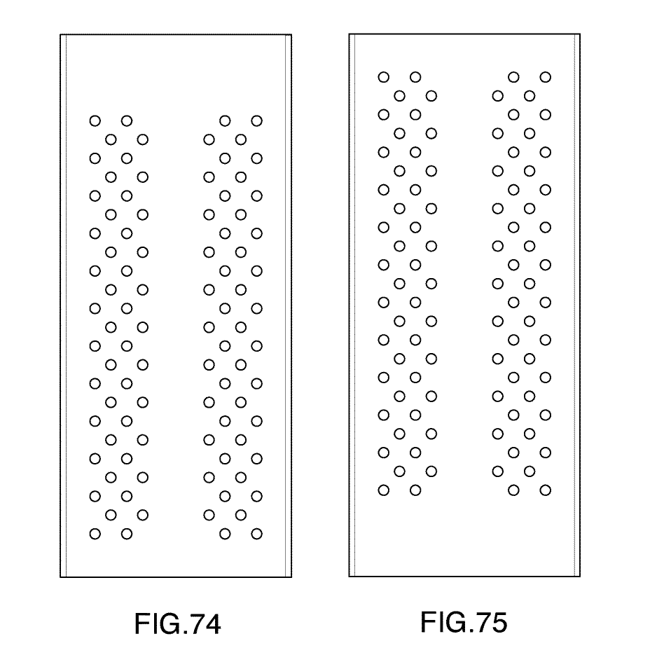

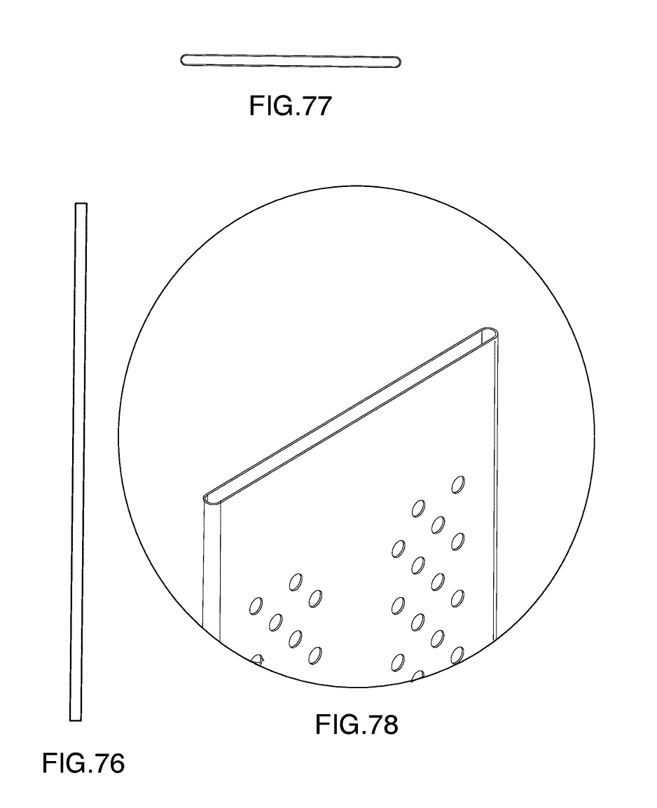

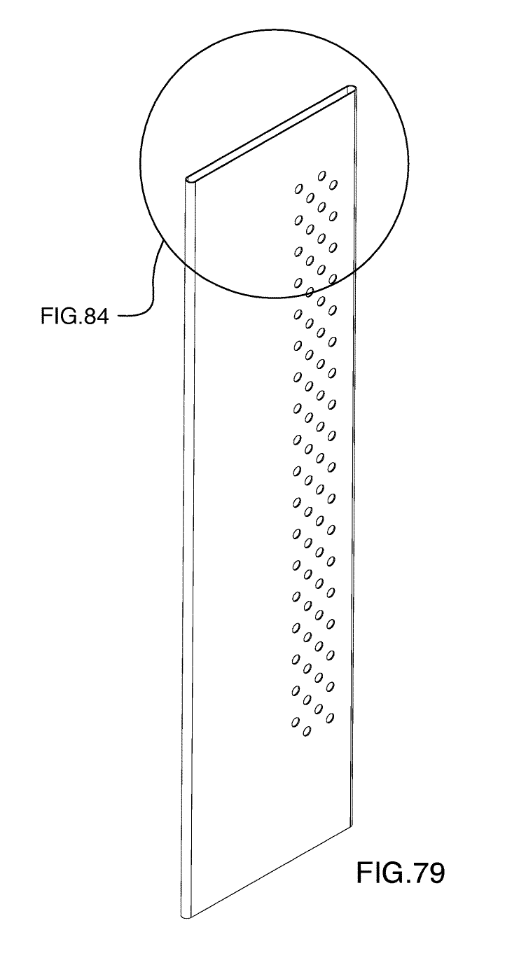

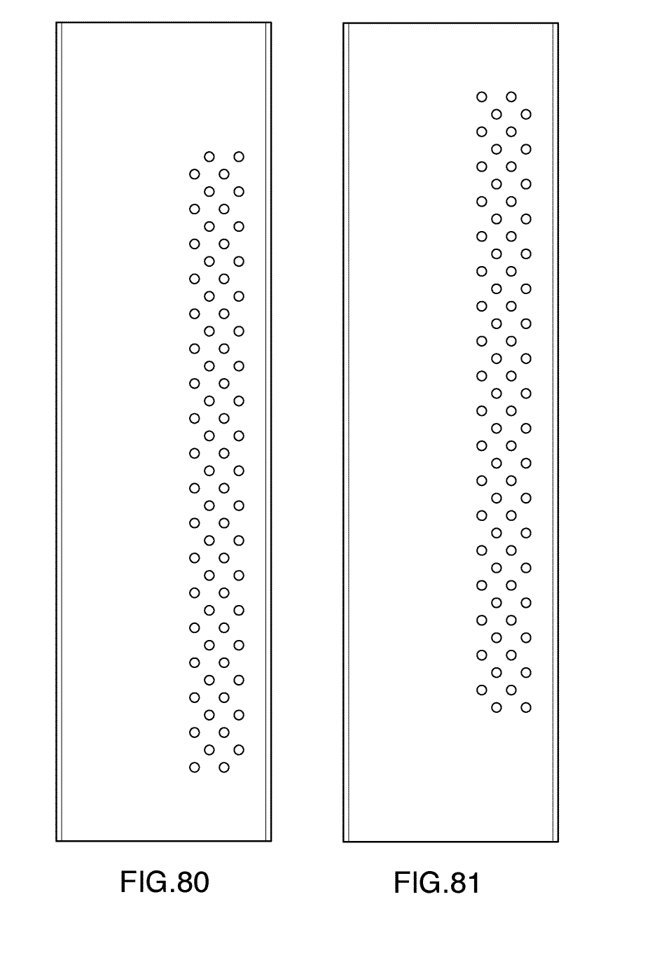

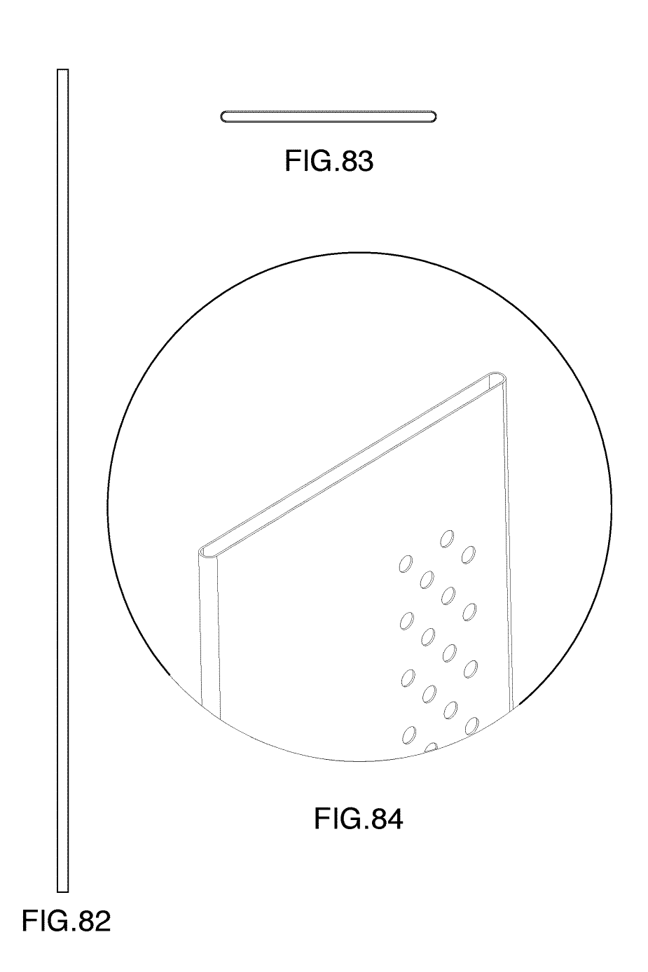

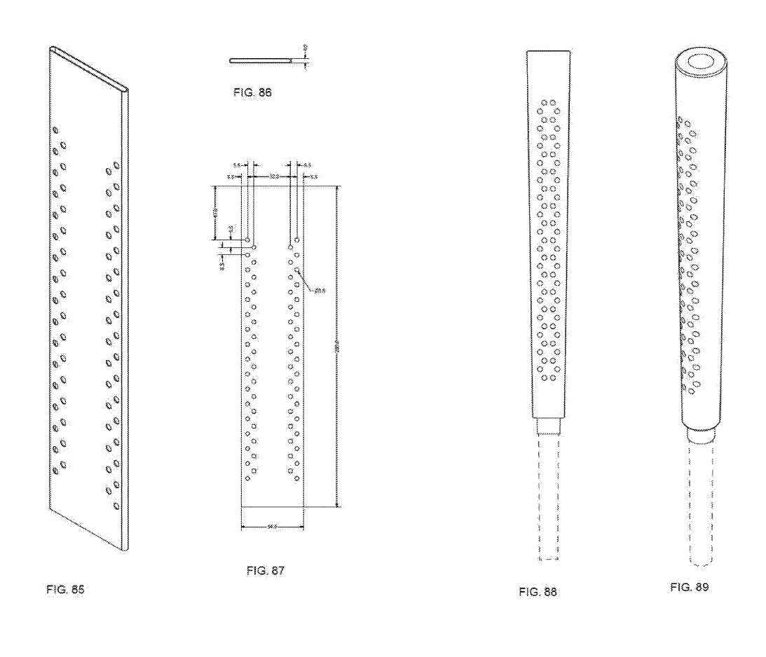

Other variations are possible, as shown in FIGS. 31-89.

Further, whereas the specification makes reference to apertures of about 3.5 mm in diameter, it has been found that apertures as small as 2.8 mm have some utility.

The invention can be embodied for any sports stick that has a portion that, in use, is typically covered with a grippable material. A golf variation is specifically shown in FIGS. 85-89, but this is not limiting and the invention can be used, for example, with lacrosse sticks, ice hockey sticks, field hockey sticks, ball hockey sticks, golf clubs, baseball bats and cricket bats.

Accordingly, the invention should be understood to be limited only by the accompanying claims, purposefully construed.

Whereas, the invention has been described in relation to the drawings attached hereto, it should be understood that other and further modifications, apart from those shown or suggested herein, may be made within the scope of this invention.

What is claimed is:

1. Apparatus for use with a sports stick of the type that has a portion which, in use, is typically covered with a grippable material, the apparatus comprising:
a body of heat shrink material, the body being adapted to receive the portion in spaced-relation and further adapted, upon receipt of heat and when in receipt of the portion, to shrink to a working size that surrounds the portion in close-fitting relation.

2. Apparatus according to claim 1, wherein the body is provided with features that, at least when the body is shrunk to the working size, renders the body grippable.

3. Apparatus according to claim 2, wherein the features are apertures.

4. Apparatus according to claim 3, wherein:
the body is a sleeve having a generally rectangular cross-section, the sleeve having generally planar side walls and top and bottom walls; and
the apertures are spaced apart from one another about 4.7 mm and each has a diameter of about 3.5 mm.

5. A kit for use with a hockey stick, the kit comprising:
apparatus according to claim 1 adapted for use with the blade of the hockey stick;
apparatus according to claim 1 adapted for use with the end of the hockey stick opposite the blade;
a ring having a relatively large external diameter and adapted to engage the end of the stick opposite the blade in gripping relation; and
a plurality of rings having a relatively small external diameter and adapter to engage the end of the stick opposite the blade in gripping relation.

6. A kit for use with a hockey stick, the kit comprising:
apparatus according to claim 2 adapted for use with the blade of the hockey stick;
apparatus according to claim 2 adapted for use with the end of the hockey stick opposite the blade;
a ring having a relatively large external diameter and adapted to engage the end of the stick opposite the blade in gripping relation; and
a plurality of rings having a relatively small external diameter and adapter to engage the end of the stick opposite the blade in gripping relation.
